(19) United States
(12) Patent Application Publication
(10) Pub. No.: US 2010/0295550 A1
(43) Pub. Date: Nov. 25, 2010

(54) ADAPTIVE ENERGY MANAGEMENT TERMINAL FOR A BATTERY

(75) Inventors: Peter J. Hopper, San Jose, CA (US); Kyuwoon Hwang, Palo Alto, CA (US); William French, San Jose, CA (US); Qingguo Liu, Santa Clara, CA (US)

Correspondence Address: Munck Carter/NSC, P.O. Drawer 800889, Dallas, TX, 75380, US

(73) Assignee: National Semiconductor Corporation, Santa Clara, CA (US)

(21) Appl. No.: 12/709,416

(22) Filed: Feb. 19, 2010

Related U.S. Application Data
(60) Provisional application No. 61/208,158, filed on Feb. 20, 2009.

(51) Int. Cl. G01N 27/416; H02J 7/00; H01M 2/14

(52) U.S. Cl. 324/430; 320/135; 320/136; 429/145

(57) ABSTRACT

A battery includes multiple conductive plates and a permeable electrolytic material and an ion membrane located between the conductive plates. The battery also includes at least one wire located within one or more of the permeable electrolytic material and the ion membrane. The at least one wire can be configured to regulate a flow of ions through the ion membrane based on an electrical signal flowing through the at least one wire. The at least one wire could also be configured to generate a magnetic field within the permeable electrolytic material based on another electrical signal flowing through the at least one wire. The battery could further include a temperature sensor wire within the permeable electrolytic material.

### CROSS-REFERENCE TO RELATED APPLICATIONS AND PRIORITY CLAIM

This application claims priority under 35 U.S.C. §119(e) to U.S. Provisional Application No. 61/208,158 filed on Feb. 20, 2009, which is hereby incorporated by reference.

This application is related to U.S. patent application Ser. No. 12/703,650 filed on Feb. 10, 2010, which claims priority to U.S. Provisional Application No. 61/207,299 filed on Feb. 10, 2009. Both of these applications are hereby incorporated by reference.

### TECHNICAL FIELD

This disclosure is generally directed to batteries. More specifically, this disclosure relates to an adaptive energy management terminal for a battery.

### BACKGROUND

Maximizing energy storage and delivery characteristics in modern stacked batteries represents an engineering optimization challenge. Many high direct current (DC) voltage applications, such as automotive battery applications, require that the batteries be stacked in series. This causes each battery cell to individually contribute to an overall high voltage DC power supply.

During usage cycles, individual battery cells deplete their charge contributions. Over time, the individual battery cells may start to contribute voltages at non-equal levels. Considering the available parameters in the design space of an idealized stack of battery cells, the rate of charging and discharging may be considered to be optimum when all of the battery cells act similarly, such as when each battery cell contributes the same amount of discharge.

Difficulties arise in achieving a state where each battery cell contributes the same amount of discharge due to the fact that an individual battery cell is stacked in series with a large number of other battery cells. The individual battery cell's electrode voltage is governed, in part, by the battery cell's electrochemical contribution but is dominated by the surrounding battery cells in the battery stack. Thus, the model of a voltage divider is applicable to a stack of battery cells. The influence of the other battery cells may dominate a signal when a voltage meter is used to measure a battery cell' individual state of charge (SOC). Therefore, it is difficult to measure an individual battery cell's state of charge when that battery cell is located in a high voltage battery stack.

### BRIEF DESCRIPTION OF THE DRAWINGS

For a more complete understanding of this disclosure, reference is now made to the following description, taken in conjunction with the accompanying drawings, in which:

FIG. 1 illustrates an example graph plotting relative permeability of a permeable electrolytic medium of a battery as a function of a state of charge of the battery according to this disclosure;

FIGS. 2A and 2B illustrate an example insulated conductive sensor wire of a magnetic sensor wound through a permeable electrolytic medium of a battery according to this disclosure;

FIGS. 3A and 3B illustrate an example battery with a permeable electrolytic medium having an embedded insulated conductive sensor wire according to this disclosure;

FIG. 4 illustrates an example battery having multiple battery plates through which an insulated conductive sensor wire has been wound according to this disclosure;

FIGS. 5 and 6 illustrate an example magnetic field that surrounds an insulated conductive sensor wire when an electrical current signal is flowing through the insulated conductive sensor wire according to this disclosure;

FIGS. 7 and 8 illustrate an example insulated conductive sensor wire embedded within a portion of a permeable electrolytic medium of a battery according to this disclosure;

FIG. 9 illustrates an example state of charge test unit according to this disclosure;

FIG. 10 illustrates an example process for providing a magnetic state of charge of a battery according to this disclosure;

FIG. 11 illustrates an example battery having a permeable electrolytic medium with an insulated conductive sensor wire and a temperature sensor wire according to this disclosure;

FIG. 12 illustrates an example battery having multiple embedded sensor wire coils according to this disclosure;

FIG. 13 illustrates an example battery having multiple sensor wire coils and a temperature sensor wire according to this disclosure;

FIG. 14A illustrates an example battery discharge control unit according to this disclosure;

FIG. 14B illustrates an example voltage barrier according to this disclosure;

FIG. 15 illustrates an example process for reducing a battery discharge rate according to this disclosure;

FIGS. 16A and 16B illustrate an example battery having a permeable electrolytic medium with an insulated conductive sensor wire and an insulated conductive control wire according to this disclosure; and

FIG. 17 illustrates another example battery discharge control unit according to this disclosure.

### DETAILED DESCRIPTION

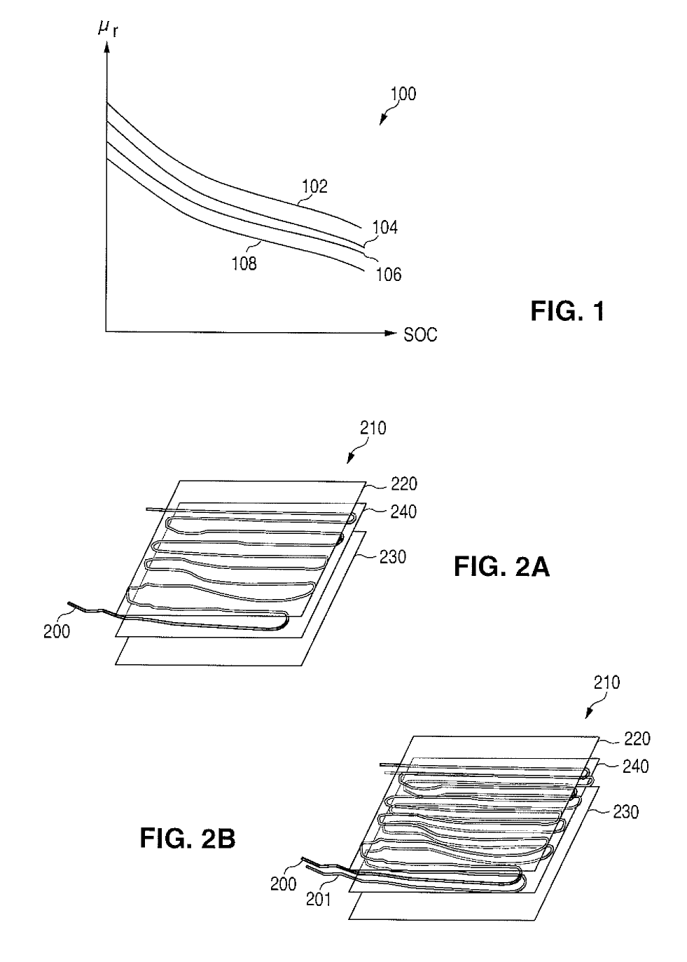

FIGS. 1 through 17 and the various embodiments used to describe the principles of the present invention in this patent document are by way of illustration only and should not be construed in any way to limit the scope of the invention. Those skilled in the art will understand that the principles of the present invention may be implemented in any type of suitably arranged battery circuit. To simplify the drawings, reference numerals from previous drawings will sometimes not be repeated for structures that have already been identified.

FIG. 1 illustrates an example graph 100 plotting relative permeability (μᵣ) of a permeable electrolytic medium of a battery as a function of a state of charge (SOC) of the battery according to this disclosure. More specifically, the graph 100 plots the relative permeability of the permeable electrolytic material as a function of the battery's SOC at four different temperatures 102-108. Lower values of the SOC are correlated with higher values of relative permeability, and higher values of the SOC are correlated with lower values of relative permeability. As shown in FIG. 1, the actual relationship between the SOC and the relative permeability is dependent upon the ambient temperature.

FIG. 2A illustrates an example insulated conductive sensor wire 200 of a magnetic sensor wound through a permeable electrolytic medium of a battery according to this disclosure. The electrolytic material is disposed between a conductive plate 220 (such as an aluminum plate) and an ion membrane 240 of an SOC battery 210. Additional electrolytic material can be disposed between the ion membrane 240 and a conductive plate 230 (such as a copper plate) of the SOC battery 210. The electrolytic material can be a complex electrolytic material with a frequency dependent impedance. In some embodiments, the conductive sensor wire 200 is made of copper material. However, other conductive material(s) may also be used in the sensor wire 200.

As shown in FIG. 2A, the conductive sensor wire 200 is wound through the permeable electrolytic medium. Winding the conductive sensor wire 200 through the permeable electrolytic medium can create an inductance when a voltage or current is applied to the conductive sensor wire 200. The sensor wire 200 is wound back and forth between the conductive plate 220 and the ion membrane 240 of the SOC battery 210. During the manufacturing process of the SOC battery 210, the sensor wire 200 is embedded in the permeable electrolytic material formed between the conductive plate 220 and the ion membrane 240.

FIG. 2B illustrates an example insulated conductive sensor wires 200, 201 of a magnetic sensor wound through a permeable electrolytic medium of a battery according to this disclosure. In some embodiments, the SOC battery 210 includes at least two sensor wires 200, 201 as shown in FIG. 2B. The second conductive sensor wire 201 also is wound through the permeable electrolytic medium. Winding the second conductive sensor wire 201 through the permeable electrolytic medium can create a capacitance between the conductive sensor wires 200, 201 when a voltage or current is applied to the conductive sensor wires 200, 201.

In some embodiments, the conductive sensor wires 200, 201 are formed from conductive tape. In other embodiments, the SOC battery 210 includes one or more conductive plates instead of, or in conjunction with, the conductive sensor wires 200, 201.

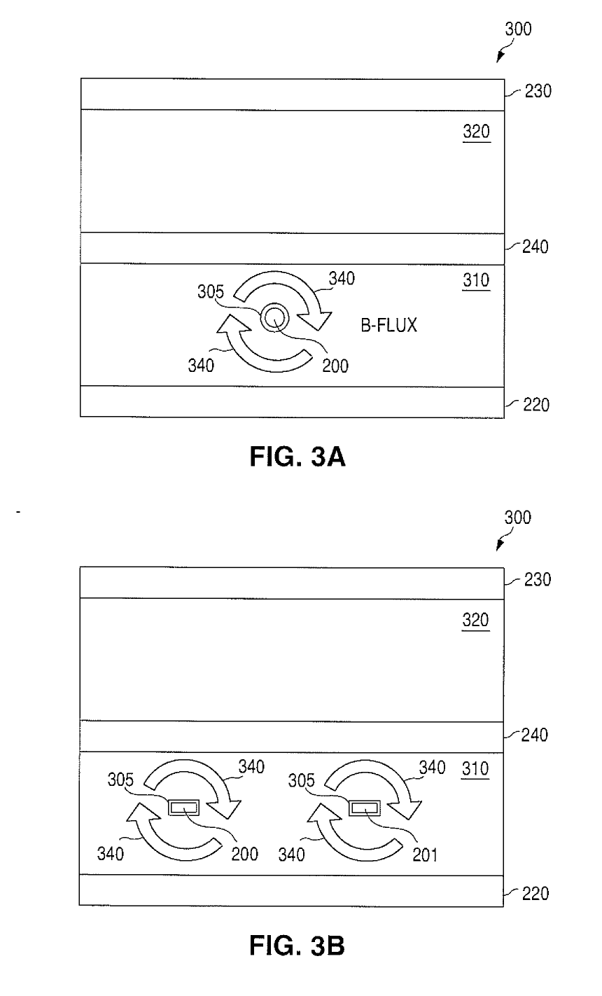

FIG. 3A illustrates an example battery 300 with a permeable electrolytic medium having an embedded insulated conductive sensor wire 200 according to this disclosure. The insulated conductive sensor wire 200 is embedded in a permeable electrolytic medium 310 between the conductive plate 220 and the ion membrane 240. The conductive sensor wire 200 includes an insulating material 305, such as 10 μm polyurethane insulation disposed around the conductive sensor wire 200. In other embodiments, the insulating material 305 is a 1 Å polyurethane insulation disposed around the conductive sensor wire 200. In yet other embodiments, the conductive sensor wire 200 does not include insulating material 305, and the conductive sensor wire 200 is a bare wire.

As shown in FIG. 3A, another body of permeable electrolytic material 320 exists between the ion membrane 240 and the conductive plate 230. In other embodiments, the insulated conductive sensor wire 200 may be embedded in the permeable electrolytic material 320 instead of the permeable electrolytic material 310.

In other embodiments as shown in FIG. 3B, the battery 300 includes a second insulated conductive sensor wire 201. The second conductor wire 201 may be embedded in the permeable electrolytic material 320 instead of the permeable electrolytic material 310.

As shown in FIG. 3B, the insulated conductive wires 200, 201 can comprise an insulated conductive tape. It will be understood that example of insulated conductive tapes 200, 201 are illustrated as cross-sections for clarity only and that actual orientation is design choice that does not depart from the scope of this disclosure. Further, although not specifically illustrated, a capacitive charge can exists between one or more of the insulated conductive wires 200, 201 and conductive plates 220, 240. The conductive sensor wire 201 includes an insulating material 305, such as 10 μm polyurethane insulation disposed around the conductive sensor wire 201. In other embodiments, the insulating material 305 is a 1 Å polyurethane insulation disposed around the conductive sensor wire 200. In yet other embodiments, the conductive sensor wire 201 does not include insulating material 305, and the conductive sensor wire 201 is a bare wire. In still other embodiments, the battery 300 includes one or more conductive plates instead of, or in conjunction with, the conductive sensor wires 200, 201.

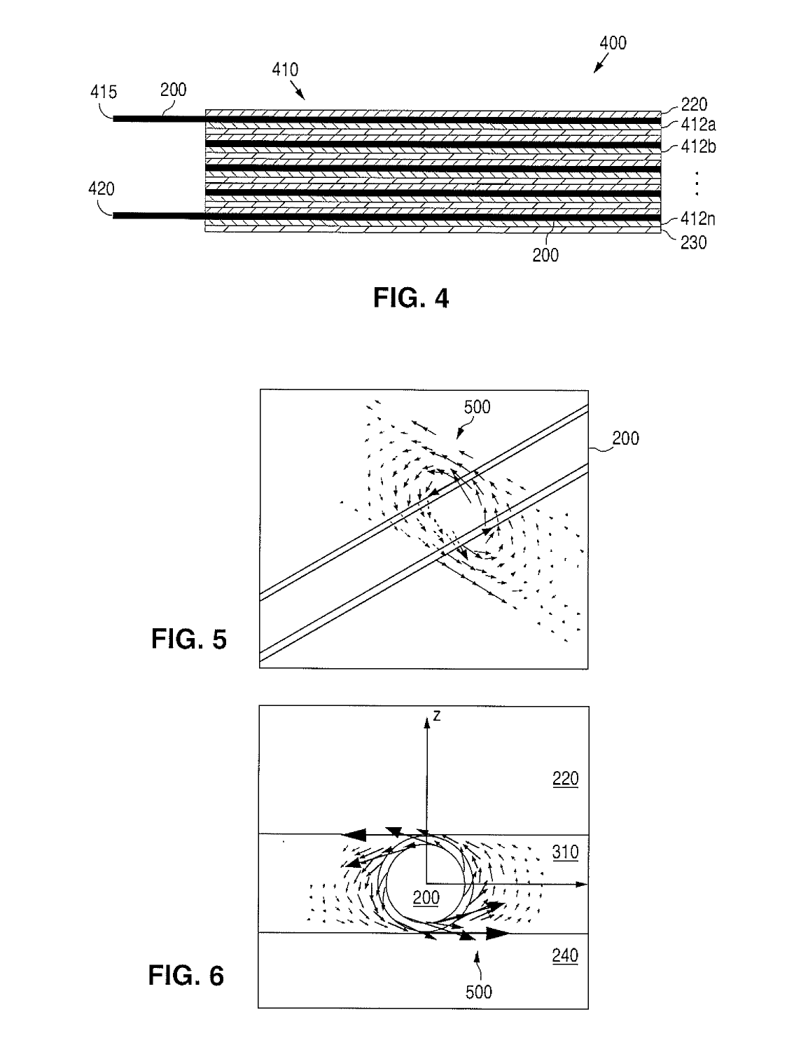

In yet other embodiments, the insulated conductive sensor wire 200 may be embedded in both the permeable electrolytic material 310 and the permeable electrolytic material 320. For example, the insulated conductive sensor wire 200 may be embedded in one layer of permeable electrolytic material 310 as shown in FIG. 3A and then extend into other levels of permeable electrolytic material. An example of this is shown in FIG. 4.

FIG. 4 illustrates an example battery 400 having multiple battery plates 410 through which an insulated conductive sensor wire has been wound according to this disclosure. For example, the battery plates 410 can form an SOC battery that has been created via a rolled and flattened process.

A first terminal end 415 of the insulated conductive sensor wire 200 enters a first layer of permeable electrolytic material 412a. The insulated conductive sensor wire 200 is wound through the first layer of permeable electrolytic material 412a. The insulated conductive sensor wire 200 is then wound through successive layers of permeable electrolytic material 412b-414n. A second terminal end 420 of the insulated conductive sensor wire 200 exits the last layer of permeable electrolytic material 412n. The battery plates 410 containing the insulated conductive sensor wire 200 are placed into an SOC battery 400. An SOC battery that contains the insulated conductive sensor wire 200 (such as an insulated copper sensor wire) is adapted for state of charge testing according to this disclosure.

As will be described more fully below, the first terminal end 415 and the second terminal end 420 of the insulated conductive sensor wire 200 are adapted to be connected to a state of charge test unit. The state of charge test unit is used to send an alternating current (AC) electrical current signal through the conductive sensor wire 200. A magnitude of the electrical current signal can be on the order of several milliamperes, for example. The electrical current signal causes the conductive sensor wire 200 to create an internal distributed magnetic field around the conductive sensor wire 200 in the body of the permeable electrolytic medium 310 (as illustrated in FIG. 3 by B-Flux 340).

FIGS. 5 and 6 illustrate an example magnetic field 500 that surrounds an insulated conductive sensor wire 200 when an electrical current signal is flowing through the insulated conductive sensor wire 200 according to this disclosure. In particular, FIG. 5 illustrates a perspective view of the magnetic field 500. As shown in FIG. 5, the direction and relative intensity of the magnetic field 500 are represented by arrows. Here, the magnetic field 500 is concentric around the axis of the conductive sensor wire 200.

FIG. 6 illustrates a cross-sectional view of the magnetic field 500. In the example illustrated in FIG. 6, the conductive sensor wire 200 is located in the electrolytic material and is in contact with a conductive plate (e.g., aluminum conductive plate 220) on one side and in contact with an ion membrane 240 on the other side.

As current is applied to the conductive sensor wire 200, the magnetic field 500 is generated. The magnetic field 500 is generally concentric around the axis of the conductive sensor wire 200. However, a field line restriction occurs at the surface of the conductive plate (such as the conductive plate 220) and at the surface of the ion membrane 240. Accordingly, the magnetic field 500 can be substantially limited in the conductive plate 220 and the ion membrane 240.

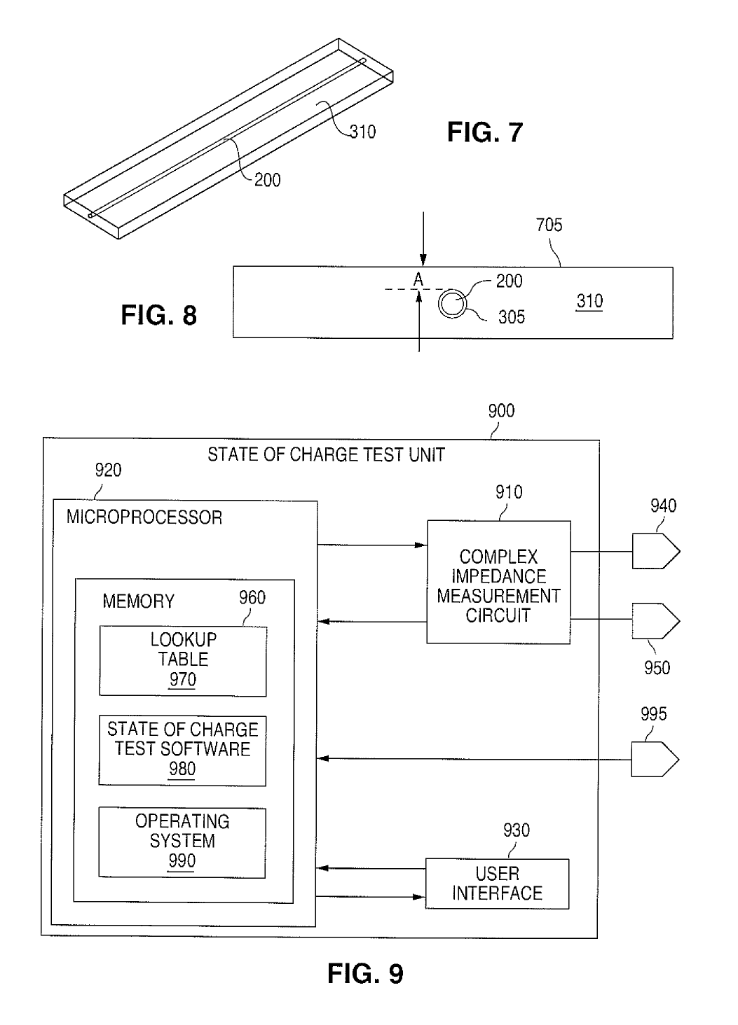

FIGS. 7 and 8 illustrate an example insulated conductive sensor wire 200 embedded within a portion of a permeable electrolytic medium 310 of a battery according to this disclosure. In particular, FIG. 7 illustrates a perspective view of a portion of the insulated conductive sensor wire 200 embedded within a portion of the permeable electrolytic medium 310. In some embodiments, the insulated conductive sensor wire 200 includes a conductive wire dimensioned to have a diameter of approximately 100 μm covered with a polyurethane or nylon insulation that is dimensioned to be approximately 10 μm thick. In other embodiments, the diameter of the conductive sensor wire 200 is in a range of approximately 10 μm to approximately 17 μm, and the thickness of the polyurethane or nylon insulating material 305 is approximately 1 μm. In some embodiments, the thickness of the polyurethane or nylon insulating material 305 is approximately 1 Å. The thickness of the electrolytic medium 310 could be approximately 100 μm.

FIG. 8 illustrates a cross-sectional view of the insulated conductive sensor wire 200 that is shown in FIG. 7. In some embodiments, the insulated conductive sensor wire 200 is embedded in the center of the permeable electrolytic medium 310. The letter “A” designates a distance between a top surface 705 of the permeable electrolytic medium 310 and the adjacent insulating material 305 of the insulated conductive sensor wire 200.

FIG. 9 illustrates an example state of charge test unit 900 according to this disclosure. The state of charge test unit 900 includes a complex impedance measurement circuit 910, a microprocessor 920, and a user interface unit 930. The complex impedance measurement circuit 910 includes a first input port 940 that connects to a first end 415 of the insulated conductive sensor wire 200 and a second input port 950 that connects to a second end 420 of the insulated conductive sensor wire 200.

The microprocessor 920 is connected to the complex impedance measurement circuit 910. The user interface unit 930 is connected to the microprocessor 920. The microprocessor 920 can include a memory 960. The memory 960 includes a state of charge look-up table (LUT) 970, a state of charge test software module 980, and an operating system 990.

Together, the microprocessor 920, the state of charge look-up table 970, the operating system 990, and the state of charge test software module 980 comprise a state of charge processor that is capable of carrying out a state of charge test function for a battery. The state of charge test unit 900 can determine the state of charge for a battery without relying upon a voltage measured at positive and negative terminals of the battery.

In some embodiments, the state of charge test unit 900 can store two or more reference state values. For example, the state of charge test unit 900 can include reference state values that correspond to a maximum charge, a half charge, and a low charge. It will be understood that illustration of these three reference states is for example purposes only and that other numbers of reference states could be used without departing from the scope of this disclosure.

In some embodiments, the LUT 970 is preconfigured and stored in the memory 960. In other embodiments, the LUT 970 is constructed by the state of charge test unit 900. For example, the state of charge test unit 900 may construct the LUT 970 at startup. As a particular example, the state of charge test unit 900 could perform a frequency sweep measurement of the battery at known states of charge to construct the LUT 970. A first measurement cycle could be performed across a frequency sweep, such as 10 MHz, 12 MHz, 14 MHz, 16 MHz, 18 MHz and 20 MHz, at a specified state of charge of the battery, such as 20% charged. It will be understood that illustration of these frequency values is for example purposes only and that other frequency values could be used without departing from the scope of this disclosure. The first measurement can also be performed across a range of temperatures of the battery such that measurement values are collected at different temperatures and different frequencies. A second measure cycle could be performed across the frequency sweep, such as 10 MHz, 12 MHz, 14 MHz, 16 MHz, 18 MHz and 20 MHz, at a different state of charge of the battery, such as 80% charged. The second measurement can also be performed across a range of temperatures of the battery such that measurement values are collected at different temperatures and different frequencies. The state of charge test unit 900 constructs the LUT 970 from the measured values from the first and second measurement cycles.

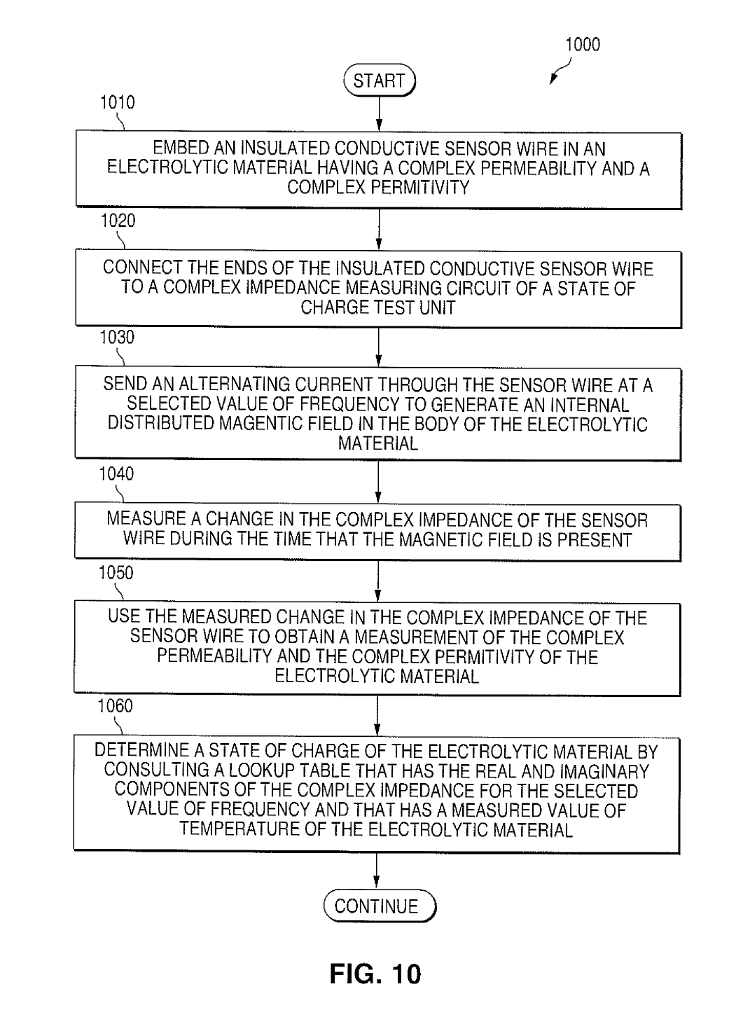

FIG. 10 illustrates an example process 1000 for providing a magnetic state of charge of a battery according to this disclosure. In block 1010, during a manufacturing process of a battery, an insulated conductive sensor wire 200 is embedded in an electrolytic material 310 and/or 320 having a complex permeability and a complex permittivity. In block 1020, the ends of the insulated conductive sensor wire 200 are connected to a complex impedance measurement circuit 910 of a state of charge test unit 900. Thereafter, in block 1030, the complex impedance measuring circuit 910 sends an AC electrical current signal (such as a radio frequency or “RF” signal) through the sensor wire 200 at a specific selected frequency to generate an internal distributed magnetic field in the body of the electrolytic material 310 and/or 320. Since the RF signal is influenced by the electrolytic material at different frequencies, the RF signal can be a swept frequency RF signal that varies in frequency from approximately one kilohertz to one hundred megahertz. Additionally, the AC signal can be applied at different power levels.

In block 1040, the complex impedance measuring circuit 910 measures a change in the complex impedance of the sensor wire 200 during the time that the magnetic field is present in the body of the electrolytic material 310 and/or 320. Here, the sensor wire 200 represents an inductor.

The measurement can be a single measurement or two or more measurements at different temperatures and/or frequencies. For example, the measurement can be a single measurement at one temperature and one frequency. As another example, the measurements could include measurements at one temperature at two or more frequencies across a frequency sweep. As yet another example, the measurements could include measurements at different temperatures and at one or more frequencies across the frequency sweep.

The measurement can be performed across the same frequency sweep used to generate the LUT 970. The frequencies used for the measurement follow the same frequency sweep or curve as the frequencies used to generate the LUT 970. However, the frequencies used for the measurement need not match the frequencies used to generate the LUT 970. For example, the measurement can be performed at 11 MHz, 13 MHz, 15 MHz, 17 MHz, 19 MHz and 21 MHz.

At high frequencies, there will be an impedance of the inductor. The high impedance of the inductor includes a complex component and a real component. The complex component is pure inductance, and the real component relates to the resistance plus all the losses associated with the system. The complex impedance measuring circuit 910 measures both the complex impedance and the real component of impedance. These values are provided to the microprocessor 920.

The inductance of the sensor wire 200 at high frequencies can depend on the nature of the permeable electrolytic material 310 and/or 320. High values of permeability of the electrolytic material 310 and/or 320 can correspond to high inductance values. Additionally, high values of permittivity of the electrolytic material 310 and/or 320 can correspond to low inductance values.

In block 1050, the microprocessor 920 uses the measured change in the complex impedance of the sensor wire 200 to obtain a measurement of the complex permeability and complex permittivity of the electrolytic material 310 and/or 320. The microprocessor 920 determines a state of charge of the electrolytic material 310 and/or 320 by consulting a look-up table 970 that includes real and imaginary components of the complex impedance and a value of the measured temperature of the electrolytic material 310 and/or 320 for the specific selected frequency.

In some embodiments of the battery and battery test system, the state of charge test unit 900 determines a state of charge of the electrolytic material 310 and/or 320 using the real component of impedance. The state of charge that corresponds to a real component of impedance can be empirically determined and that information can be stored in the look-up table 970. The microprocessor 920 of the state of charge test unit 900 is then able to subsequently use measured values of the real component of impedance to determine the corresponding state of charge in the electrolytic material 310.

The correlations between the values of complex permeability and complex permittivity and the values of state of charge may be non-linear. The microprocessor 920 accesses the look-up table 970 that can contain empirically determined correlations between the values of the complex permeability and complex permittivity and the values of the state of charge. Because the values of the complex permeability and complex permittivity are temperature dependent, the look-up table 970 also can contain empirically determined correlations for different temperature values. The look-up table 970 may further contain the empirically determined correlations for different values of frequency. The use of additional frequencies increases the accuracy of the determination of the state of charge.

As described above, the complex permeability of a permeable electrolytic material varies with changes in temperature. Therefore, the state of charge test unit 900 can utilize information concerning the temperature of the permeable electrolytic material to determine the state of charge of the battery. As shown in FIG. 9, the state of charge test unit 900 includes a temperature information input port 995 that receives temperature information. The temperature information that is received at the input port 995 is provided to the microprocessor 920.

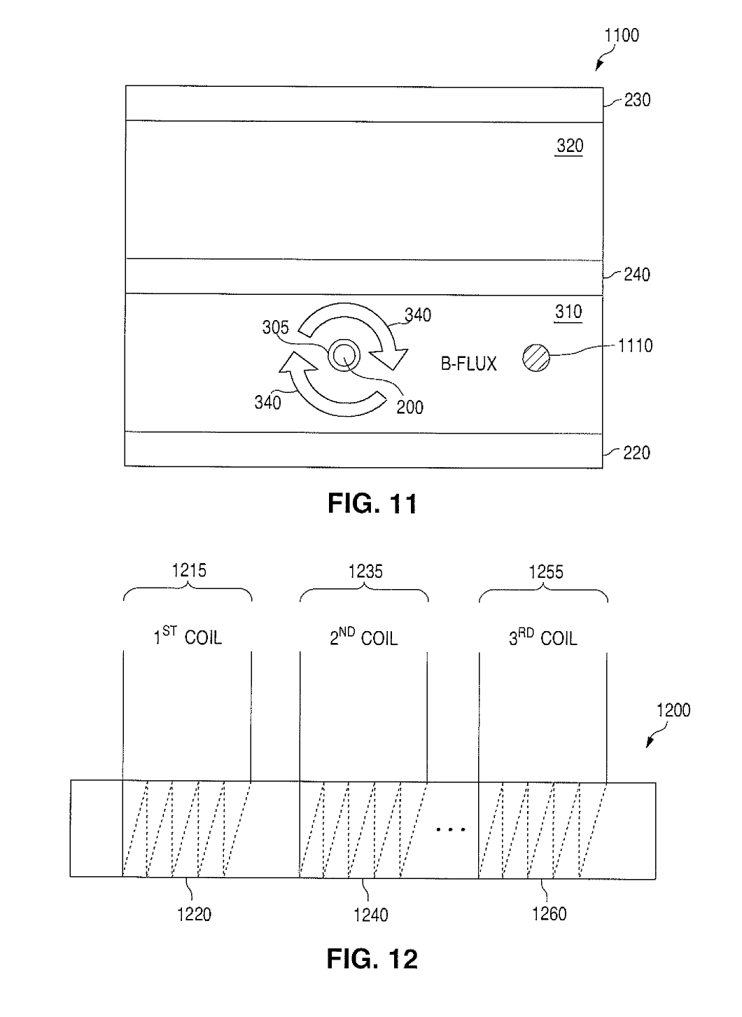

In some embodiments, the temperature of the permeable electrolytic material is obtained from a temperature sensor wire that is embedded in the permeable electrolytic material in the same manner as the insulated conductive sensor wire 200. FIG. 11 illustrates an example battery 1100 having a permeable electrolytic medium 310 with an insulated conductive sensor wire 200 and a temperature sensor wire 1110 according to this disclosure. The temperature sensor wire 1110 can measure a temperature of the permeable electrolytic medium 310. The temperature sensor wire 1110 is connected to the temperature information input port 995 that is shown in FIG. 9.

The temperature sensor wire 1110 can be used to detect an increase in the temperature of the electrolytic material 310, such as in a thermal run-away (discussed in more detail below). The temperature sensor 1110 can provide an indication to the state of charge test unit 900 that a thermal run-away condition is imminent or occurring. In some embodiments, the look-up table 970 includes temperature information for use in the detection of thermal run-away.

In some embodiments, the temperature sensor 1110 can be used to determine a state of charge when charging the battery. The temperature sensor 1110 can monitor the temperature of a battery as the battery is charged. Accordingly, the temperature sensor 1110 can provide temperature readings during a charge to a charging unit (not shown) to regulate the charging duration. For example, the temperature sensor 1110 can provide the temperature readings to a charging unit and, in response to the charging unit determining that the battery is fully charged, the charging unit ceases the charging operation. In some embodiments, the look-up table 970 includes temperature information for use in the charging operation.

This disclosure is not limited to the use of a conductive sensor wire 200 with one coil. In some embodiments, multiple coils of the conductive sensor wire 200 may be used simultaneously. FIG. 12 illustrates an example battery 1200 having multiple embedded sensor wire coils according to this disclosure. A first coil 1215 of sensor wire is wound within a first portion 1220 of battery plates. A second coil 1235 of sensor wire is wound within a second portion 1240 of the battery plates. An “Nth” coil of sensor wire 1255 is wound within an “Nth” portion 1260 of battery plates. Each coil 1215, 1235, and 1255 may be independently operated to measure the state of charge of its respective portion of the battery plates of the battery.

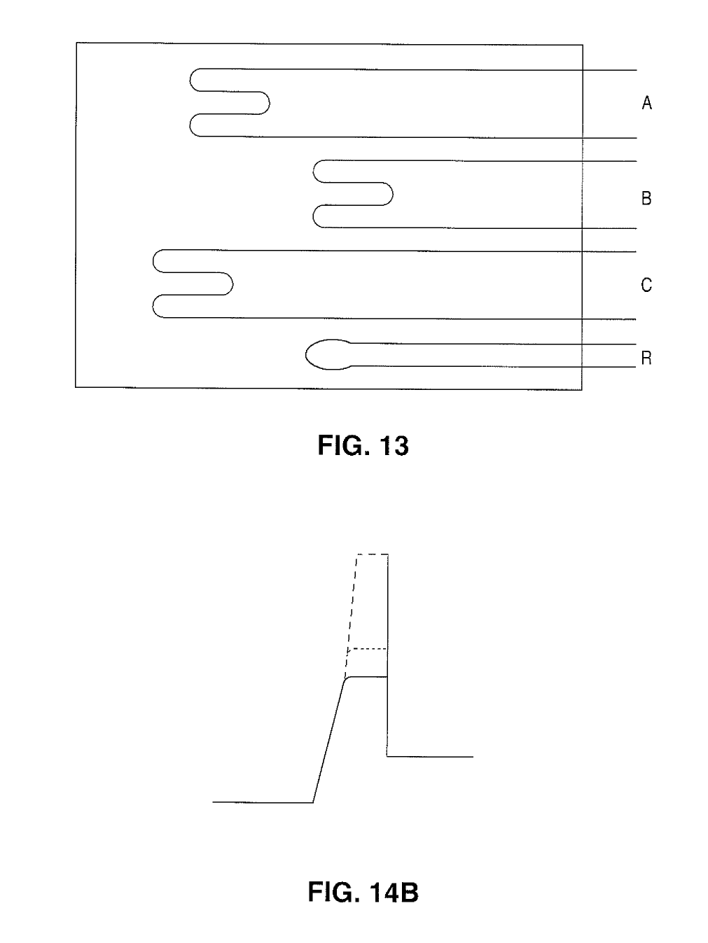

FIG. 13 illustrates an example battery having multiple sensor wire coils (A, B, C) and a temperature sensor wire (R) according to this disclosure. The three sensor wire coils (A, B, C) can determine a state of charge of the battery at their respective locations. The temperature sensor wire (R) measures the temperature of the battery. The measurements are provided to the state of charge test unit 900 in the manner that has been previously described.

The battery test system's measurement of the complex permeability of the permeable electrolytic material is used to determine a state of charge in the permeable electrolytic material. The measurement of the complex permeability determines both the complex impedance and the real component of impedance.

In some embodiments of the battery and battery test system, the state of charge test unit 900 determines a state of charge of the electrolytic material 310 and/or 320 using the real component of impedance. The state of charge that corresponds to a real component of impedance can be empirically determined and that information can be stored in the look-up table 970. The microprocessor 920 of the state of charge test unit 900 is then able to subsequently use measured values of the real component of impedance to determine the corresponding state of charge in the electrolytic material 310.

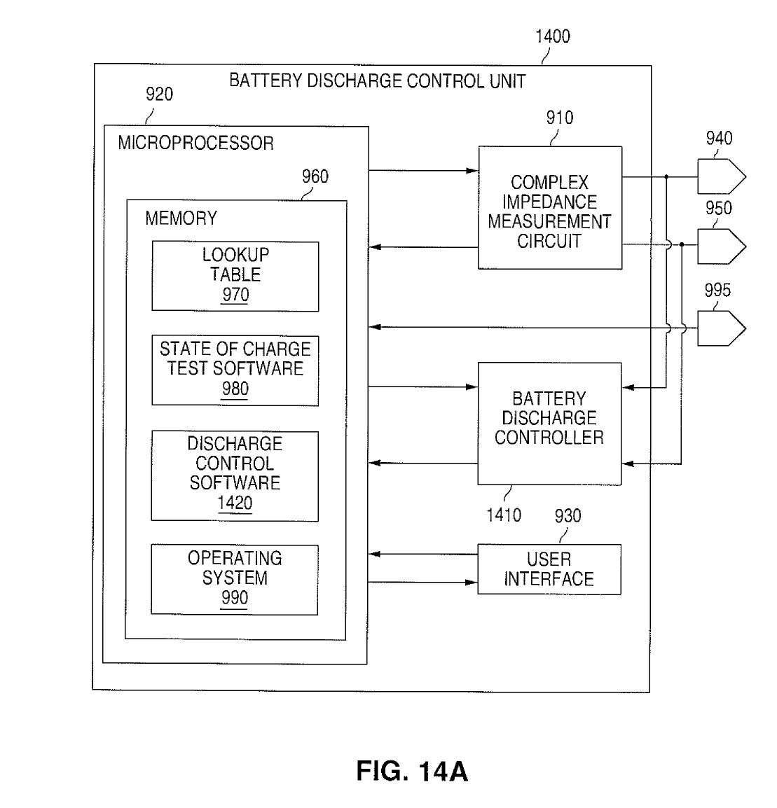

In some embodiments, a number of batteries are coupled together in series and/or in parallel as a battery stack. The SOC of an individual battery cell in a battery stack can be measured using the process 1000 described above. However, individual batteries in a battery stack may discharge at different rates. For example, a first battery cell in a battery stack may discharge more rapidly than a second battery cell in the battery stack. FIG. 14A illustrates an example battery discharge control unit 1400 according to this disclosure. The battery discharge control unit 1400 can slow down the discharge rate of the “faster runner” battery cell so that (1) the “faster runner” battery cell does not end up becoming a “weak link” in the chain of batteries in the battery stack and (2) the battery stack does not have to be shut down earlier that it would otherwise have to be shut down in an optimal case.

As shown in FIG. 14A, the battery discharge control unit 1400 can include various components 910-995 and associated functionalities of the state of charge test unit 900 described above with respect of FIGS. 9 through 13. In some embodiments, the sensor wire 200 is also used as a control wire to control the rate of discharge of an individual battery cell (although a separate control wire could also be used).

The battery discharge control unit 1400 also includes a battery discharge controller 1410. The battery discharge controller 1410 can receive inputs from the first terminal end 415 and second terminal end 420 of the sensor wire 200 via the nodes 940 and 950. The battery discharge controller 1410 can be coupled in parallel with the complex impedance measurement circuit 910. The battery discharge controller 1410 is also coupled to the microprocessor 920, which includes battery discharge control software 1420 within the memory 960.

Together, the microprocessor 920, the state of charge look-up table 970, the state of charge test software module 980 and the battery discharge control software 1420 comprise (1) a state of charge processor that is cable of carrying out the state of charge test function for a battery and (2) a battery discharge processor that is capable of controlling a battery discharge rate. The battery discharge control unit 1410 can perform a process to control the discharge rate of a battery.

In one aspect of operation, during a first time period, the state of charge of the battery is monitored by the insulated conductive sensor wire 200 in the manner that has been described above. After that, under the control of a timer (not shown) in the battery discharge controller 1410, the state of charge monitoring function is suspended, and the battery discharge control function is activated using the insulated conductive sensor wire 200 for a second time period. When the battery discharge control function is activated, the insulated conductive sensor wire 200 acts as a control wire.

The first time period for state of charge monitoring can be much longer in duration than the second time period for controlling the battery discharge rate. For example, the first time period may be on the order of tens of seconds (or more), and the second time period may be on the order of microseconds to milliseconds. In some embodiments, the second time period may be on the order of several nanoseconds.

During the second time period, the battery discharge controller 1410 causes a high value of voltage to be applied to the conductive sensor wire 200 to decrease the flow of ions through the ion exchange membrane of the battery. The value of voltage that is applied to the conductive sensor wire 200 to decrease the flow of ions can be high when compared to the low value of voltage that is applied to monitor the state of charge of the battery. For example, the voltage applied to the insulated conductive sensor wire 200 during the second time period to decrease the flow of ions can be 100V, while the voltage applied to the insulated conductive sensor wire 200 during the first time period to monitor the state of charge of the battery can be 100 mV.

Those of ordinary skill in the art will recognize that various alternatives exist for the control signal applied to sensor wire 200. For example, the signal applied to the conductive sensor wire 200 to decrease the flow of ions can be pulsed or not pulsed. Additionally, a pulsed voltage can be applied to the conductive sensor wire 200 to decrease the flow of ions. In another example, a non-pulsed current can be injected into the conductive sensor wire 200 to decrease the flow of ions. Furthermore, the conductive sensor wire 200 can be insulated for use when a voltage is applied and non-insulated (e.g., bare) for use when a current is applied.

When the voltage is applied to (or current injected into) the insulated conductive sensor wire 200, the presence of the high voltage creates a voltage barrier as shown in FIG. 14B. The voltage barrier decreases the flow of ions through the ion exchange membrane 240 of the battery. The decrease of the flow of ions causes the energy contribution of the battery to the battery stack to decrease, meaning the battery discharges at a slower rate. In some embodiments, the conductive sensor wire 200 can be inside the ion exchange membrane 240 of the battery cell. Alternatively, the conductive sensor wire 200 can be adjacent to the ion exchange membrane 240 of the battery.

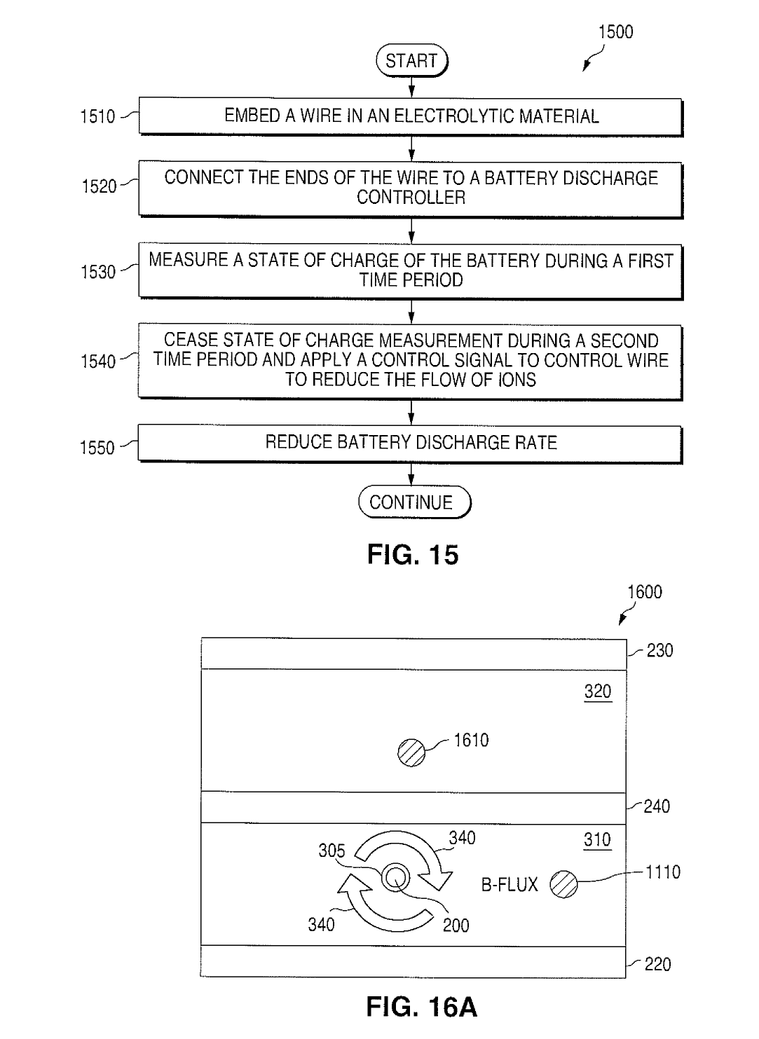

FIG. 15 illustrates an example process 1500 for reducing a battery discharge rate according to this disclosure. In block 1510, during a manufacturing process of a battery, a conductive sensor wire 200 is embedded in an electrolytic material 310 and/or 320. In block 1520, the first terminal end 415 and the second terminal end 420 of the insulated conductive sensor wire 200 are connected to a battery discharge control unit 1400. For example, the terminal ends 415 and 420 can be connected to a complex impedance measurement circuit 910 of the battery discharge control unit 1400. Additionally, the first terminal end 415 and the second terminal end 420 of the insulated conductive sensor wire 200 can be connected to a battery discharge controller 1410 in the battery discharge control unit 1400. Note that the connections described in block 1520 could occur during a single connection of the terminal ends 410 and 420 to the input ports 940 and 950.

In block 1530, during a first time period, a state of charge of the electrolytic material 310 is measured in the battery that contains the conductive sensor wire 200. In block 1540, during a second time period, the measurement of the state of charge ceases, and a control signal is applied to the conductive sensor wire 200. The control signal can be any of a high voltage signal, a pulsed high voltage signal, or a current injected into the conductive sensor wire 200. The presence of the high voltage or the injected current (which induces a voltage) reduces the flow of ions through the battery and thereby reduces the discharge rate of the battery in block 1550.

In some embodiments, the state of charge measurement voltage and the high voltage for reducing the flow of ions are applied at the same time. The voltage signal that is applied to the conductive sensor wire 200 would then comprise a large DC voltage (such as 100 V) for reducing the flow of ions in the battery and a small AC voltage (such as 100 mV) for measuring the state of charge. Accordingly, the battery discharge control unit 1400 can include a decoupling capacitor (not shown) in order to facilitate delivery of the large DC voltage and small AC voltage.

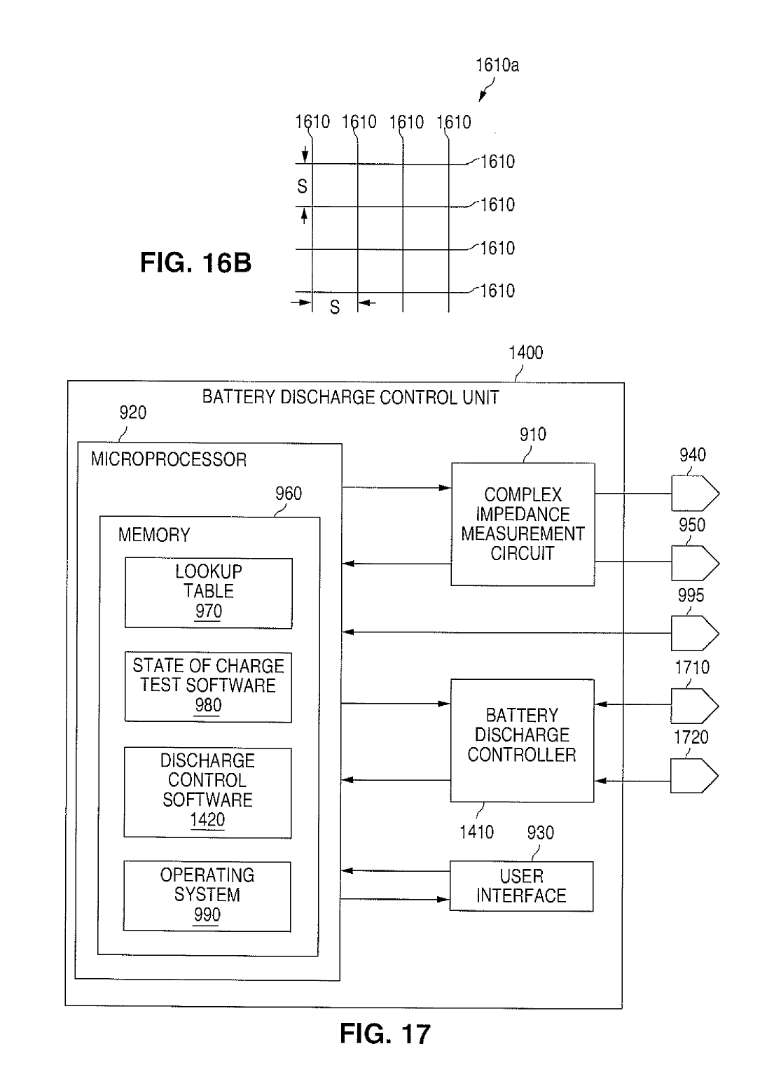

FIGS. 16A and 16B illustrate an example battery 1600 having a permeable electrolytic medium with an conductive sensor wire and a conductive control wire according to this disclosure. The battery 1600 includes the conductive sensor wire 200 and temperature wire sensor 1110 that are embedded within the permeable electrolytic medium 310 between the conductive plate 220 and the ion membrane 240. The battery 1600 also includes a conductive control wire 1610 that is embedded within the permeable electrolytic medium 320 between the conductive plate 330 and the ion membrane 240. In some embodiments, the control wire 1610 could be embedded inside or adjacent to the ion membrane 240.

The control wire 1610 can be embedded during a manufacturing process of the battery 1600. The conductive control wire 1610 can include an insulating material, such as 10 μm polyurethane insulation disposed around the conductive control wire 1610. In some embodiments, the thickness of the polyurethane or nylon insulating material 305 is approximately 1 Å. In other embodiments, the control wire 1610 does not include an insulating material; that is, the control wire 1610 comprises a bare wire.

As shown in FIG. 16B, in some embodiments, the control wire 1610 could be formed as a wire grid or a wire mesh 1610a within the battery 1600 before a rolling or flattening process of the battery. The wire grid or mesh 1610a can include multiple control wires 1610 that could be dimensioned to have a spacing (S) of approximately 10 μm between the centers of each control wire 1610.

The control wire 1610 or wire grid or mesh 1610a can be used as an intrinsic active gate to control the flow of ions through the individual battery cell in a manner that is similar to the action of a field effect transistor. For example, a high voltage can be applied, such as a pulsed voltage, to the wire grid or mesh 1610a to decrease the flow of ions through the ion exchange Membrane 240 of the battery 1600. The decrease of the flow of ions causes the battery 1610 to discharge stored energy at a slower rate.

A high voltage can be applied through the wire grid or mesh 1610a that is sufficiently large to regulate (inhibit or “pinch off”) the flow of ions through the battery 1600. The high voltage can be pulsed. The flow of ions may be sufficiently reduced to achieve a desired result of slowing the rate of discharge of the battery. Therefore, in some embodiments, the wire grid or mesh 1610a could be embedded such that the wire grid or mesh 1610a does not extend across the width of an entire battery cell in order to provide the desired reduction in ion flow.

Additionally, a current can be injected through the wire grid or mesh 1610a that is sufficiently large to regulate (inhibit or “pinch off”) the flow of ions through the battery 1600. The current can be constant (that is, non-pulsed), and the wire grid or mesh 1610a can include a plurality of bare wires (that is, non-insulated wires). The flow of ions may be sufficiently reduced to achieve a desired result of slowing the rate of discharge of the battery. Therefore, in some embodiments, the wire grid or mesh 1610a could be embedded such that the wire grid or mesh 1610a does not extend across the width of an entire battery cell in order to provide the desired reduction in ion flow.

FIG. 17 illustrates another example battery discharge control unit 1400 according to this disclosure. The battery discharge controller 1410 is connected to the wire grid or mesh 1610a through input ports 1710 and 1720. The first input port 1710 connects to a first terminal end of the wire grid or mesh 1610a, and the second input port 1720 connects to a second terminal end of the wire grid or mesh 1610a.

In some examples, a gasoline powered vehicle may include a battery with adaptive energy management according to this disclosure. The battery could have an embedded conductive sensor wire 200, insulated conductive control wire 1610 (or wire grid or mesh 1610a), and a battery discharge control unit 1400 described above.

In addition, where a conventional gasoline powered vehicle may include only one battery, gasoline-electric hybrid vehicles can include a significant number of batteries. It is very important that the electric charge on each of the batteries be maintained within an appropriate range. If the charge on a battery is too high or too low, the battery may be damaged. For example, if a first battery discharges energy at a discharge rate that is faster than the remaining batteries, the first battery can start to appear as a resistive load to the remaining batteries. As energy is delivered through the first battery (now acting as a resistive load due to the lower charge state), the electrolytic material 310 begins to increase in temperature. As the electrolytic material 310 begins to increase in temperature, the resistive value of the first battery increases. This condition is referred to as thermal run-away and can result in permanent and severe damage to the battery 1910a.

The battery discharge control system may be used to conveniently and efficiently control the rate of discharge of each of multiple batteries in the vehicle. In conventional battery stacks, it is difficult to determine the state of charge of a single battery due to the voltage divider effect of the other adjacent batteries. It is also difficult to regulate the rate of discharge of a single battery. The battery and battery discharge control systems described above overcome this problem by allowing the state of charge of each battery to be quickly and easily determined and, thereafter, controlling a rate of energy discharge from one or more of the batteries.

It may be advantageous to set forth definitions of certain words and phrases that have been used within this patent document. Terms and phrases such as “above,” “below,” “front side,” and “backside” when used with reference to the drawings simply refer to aspects of certain structures when viewed at particular directions and are not limiting. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a battery comprising at least one wire; and
a battery discharge control circuit coupled to the at least one wire, the battery discharge control circuit configured to regulate an energy discharge rate of the battery.

2. The system of claim 1, wherein the battery discharge control circuit is configured to provide a first electrical signal to the at least one wire in order to regulate a flow of ions through an ion membrane of the battery.

3. The system of claim 2, wherein the first electrical signal comprises a voltage applied to the at least one wire.

4. The system of claim 2, wherein the first electrical signal comprises a current injected into the at least one wire.

5. The system of claim 2, further comprising an impedance measurement circuit configured to provide a second electrical signal to the at least one wire in order to generate a magnetic field.

6. The system of claim 5, wherein the at least one wire comprises:
a first wire coupled to the battery discharge control circuit and located within a first permeable electrolytic material of the battery; and
a second wire coupled to the impedance measurement circuit and located within a second permeable electrolytic material of the battery.

7. The system of claim 1, wherein the battery discharge control circuit is configured to:
measure an inductance of the at least one wire when a magnetic field is present within a permeable electrolytic material of the battery; and
use a measured change in the inductance of the at least one wire to obtain a measurement of a complex permeability of the permeable electrolytic material, wherein the battery discharge control circuit is configured to use the measurement of the complex permeability to determine a state of charge of the battery.

8. The system of claim 1, wherein the at least one wire comprises a wire mesh or grid.

9. A battery comprising:
multiple conductive plates;
a permeable electrolytic material and an ion membrane located between the conductive plates; and
at least one wire located within one or more of the permeable electrolytic material and the ion membrane.

10. The battery of claim 9, further comprising:
a terminal coupled to a first end of the at least one wire; and
a second terminal coupled to a second end of the at least one wire.

11. The battery of claim 9, wherein the at least one wire is configured to generate a barrier within the permeable electrolytic material based on an electrical signal flowing through the at least one wire.

12. The battery of claim 9, wherein the at least one wire is configured to regulate a flow of ions through the ion membrane based on an electrical signal flowing through the at least one wire.

13. The battery of claim 12, wherein:
the battery further comprises a second permeable electrolytic material located between the conductive plates; and
the at least one wire comprises:
a first wire located within the permeable electrolytic material; and
a second wire located within the second permeable electrolytic material.

14. The battery of claim 13, wherein the at least one wire comprises a wire mesh or grid.

15. The battery of claim 12, wherein the electrical signal comprises one of: a voltage applied to the at least one wire, and a current injected into the at least one wire.

16. A method comprising:
applying an electrical signal to at least one wire embedded within a battery; and
regulating a rate of flow of energy from the battery using the electrical signal.

17. The method of claim 16, wherein regulating the rate of flow of energy comprises:
regulating a flow of ions across an ion membrane of the battery using the electrical signal.

18. The method of claim 17, wherein regulating the flow of ions across the ion membrane of the battery using the electrical signal comprises at least one of:
applying a voltage to the at least one wire; and
injecting a current into the at least one wire.

19. The method of claim 16, further comprising:
measuring a change in an impedance of the at least one wire when a magnetic field is present; and
determining a state of charge of the battery based on the measured change in the impedance of the at least one wire.

20. The method of claim 19, wherein regulating the rate of flow of energy is based on the determined state of charge of the battery.
